(19) United States
(12) Patent Application Publication
(10) Pub. No.: US 2025/0117820 A1
(43) Pub. Date: Apr. 10, 2025

(54) SYSTEM AND METHOD FOR DETERMINING TIERED CREDIT CARD BENEFITS

(71) Applicant: CORPUS & COMPANY, HUDSON, OH (US)

(72) Inventor: THOMAS A. CORPUS, HUDSON, OH (US)

(21) Appl. No.: 18/905,823

(22) Filed: Oct. 3, 2024

Related U.S. Application Data
(60) Provisional application No. 63/587,893, filed on Oct. 4, 2023.

(51) Int. Cl. G06Q 30/0214

(52) U.S. Cl. CPC G06Q 30/0214

(57) ABSTRACT

A system for determining tiered and non-tiered benefits for an account holder of a payment card including a referral component which stores data relating to referrals made by the account holder and spending data of the account holder relating to spending on subscription services. The system may determine benefits to be distributed to the account holder based on the referral data and the spending data, as well as spending data relating to the spending of subsequent users referred by the account holder. The system may or may not additionally receive spending data provided by subscription providers.

### BACKGROUND

Credit cards are an integral part of daily life for consumers, retailers, and financial institutions; and almost every adult has at least one. Consequently, they are one of the most widespread revenue generators for financial institutions. Competition between credit card providers has grown rapidly. To gain a competitive advantage, these providers often offer various incentives and utilize a range of promotional marketing strategies and techniques, all of which can be very expensive.

### BRIEF SUMMARY

As shown throughout this disclosure, an improved system and payment card is presented that addresses the above issues.

According to an embodiment of the hearing device, the hearing device comprises a registration component configured to store user-identifying information of a user account, a benefit calculation component having a referral database, the referral database storing referral records indicating a number of referrals made by an account holder of the user account, the benefit calculation component configured to determine a benefit based on the number of referrals made by the account holder; and a benefit distribution component configured to distribute or credit the benefit to the user account based on the number of referrals made by the account holder.

In various embodiments, the account holder makes a referral to a second account holder of a second user account; the referral may be determined in the benefit calculation component when the second user account is created; the second account holder may make a second referral to a third account holder of a third user account, and the first user account may receive a first benefit as a result of the second referral and the second user account may receive a second benefit as a result of the second referral; the first benefit and the second benefit may be equal amounts or equal percentages of spend; the first benefit and the second benefit may be determined according to a tiered benefit structure that assigns different amounts to the first and second benefits, the registration component may be configured to identify subscription information based on credit card transaction data, the system may further comprise a network of user accounts including the at least one user account wherein benefits to all of the user accounts are determined based on the number of user accounts in the network; the benefits may be additionally determined by a number of subsequent referrals made by an additional account holder referred by the account holder; the benefits may be additionally determined based on a period of time in which the referrals are made; the benefit may be a discount of the subscription service, cash back, cash payments, points, a credit, or a percentage of spend; the registration component may be configured to store payment card status and spend information related to a payment card of the first user account and of the referred user accounts, the payment card status and spend information indicating whether the first user account and the referred user accounts are in possession of the payment card, payment categories, and an amount of spend on the payment card, and the benefit calculation component may be configured to determine the benefit based on the payment card status of the user account and the referred user accounts or spend information of the user account on the payment card and the spend information of the referred user accounts on the payment card; and the benefit may be a discount of a certain category or type of spend, cash back, cash payments, points, credits or a percentage of the spend for the first user account or the subsequent user accounts.

In another embodiment, a method for determining tiered and non-tiered benefits may comprise registering a user account; issuing a payment card recording issuance of the payment card; recording transaction data of spending using the payment card; registering subsequent user accounts; determining whether the subsequent user accounts were referred by an account holder of the user account; determining benefits earned by the user account based on the issuance of payment cards to the subsequent user accounts or the transaction data of spending using the payment card by the user account and subsequent accounts referred; distributing the benefits to a user account. In various embodiments, the method may further comprise determining whether the transaction data includes charges made toward subscription services; and determining the benefits earned by the user account based on the charges made toward the subscription services.

In another embodiment, a system may comprise a registration component configured to store user-identifying information of a user account; a benefit calculation component having a referral database, the referral database identifying at least one account referred by the account holder of the user account, the at least one account referred by the account holder being identified as in a shared network with the user account and each of the other ones of the at least one account referred by the account holder, wherein the benefit calculation is configured to determine a benefit for the user account and each of the at least one account referred by the account holder based on a number of user accounts in the shared network; and a benefit distribution component configured to distribute or credit the benefit to the user account.

In various embodiments, the benefits of all members of the shared network may be equal; the benefit may be a percentage of cash back spent on a subscription service; the number of members of the shared network may be capped at a predetermined maximum.

Financial institutions must invest heavily in marketing their credit cards to gain new account holders, as well as retain existing users. A way to reduce the costs associated with issuing new credit cards is to offer consumers a set of benefits, which may be tiered, that can increase or decrease directly, or indirectly, with how many other people existing card holders can get to sign up for a credit card. That is, existing card holders can be incentivized to get other consumers to sign up for a credit card by offering them tiered, or non-tiered, levels of benefits based on how many additional consumers they virally market the credit card to, thus creating a peer-to-peer model for marketing a credit card to new users.

Today's economy is often referred to as the ‘Subscription Economy.’ There are many reasons why consumers prefer a subscription economy, including that consumers don't have to pay out large quantities of money upfront to purchase or use a good or service. Consumers additionally prefer an ongoing relationship with a company and do not want to continually be renewing their purchases. On the other hand, companies benefit from the certainty that an on-going revenue stream from their customers provides, along with the predictability of inventory planning and staffing. One example common in the subscription economy is the streaming of entertainment and gaming, where consumers subscribe to a streaming service to watch TV, movies, listen to music, play video games, etc.

A Subscription Card can take advantage of both the peer-to-peer model and the subscription economy. For example, a bank may issue a Subscription Card to an account holder that provides benefits related to streaming entertainment and gaming subscription services that the account holder is subscribed to or will subscribe to. As described in this application, customers-both the initial credit card holder as well as future consumers they market the card to-can be incentivized to refer other people to sign up for the Subscription Card by way of receiving a benefit, or tiered set of benefits, on or related to their streaming entertainment and gaming subscriptions billed to their credit card account with each new account holder they refer. It should be known that this same process and system for identifying, tracking, calculating and delivering benefits to a credit card, which may be tiered, that can increase or decrease directly, or indirectly, with how many other people existing card holders can get to sign up for that credit card, can be applied holistically to a credit card, including all or part of its associated spend, or for merely having a credit card, and not be limited to a certain category or categories, such as subscription services.

Together, a viral, peer-to-peer subscription marketing system or model (the Subscription Card) can be used to help alleviate problems faced by the banking and subscription industries to issue new, affordable credit cards. Further, a model can be created that encourages active, recurring use of the Subscription Card by rewarding new and recurring subscription purchases.

According to the present disclosure, a system for determining tiered credit card benefits is described. While the present Subscription Card will be described as a credit card, it should be understood that it can instead be a variety of payment cards, physical or digital, such as debit cards, prepaid cards, gift cards, and the like. The system can involve an input or registration component in which a user enters information to set up a user account. Alternatively, a bank, financial institution or other third-party may enter the information on behalf of a user to set up the user account. The user account is associated with at least one credit card number. The Subscription Card is issued by a bank or other financial institution. Optionally, the Subscription Card can be co-branded or issued in partnership with a third-party company. The bank may issue the Subscription Card providing targeted benefits associated with the subscription economy. The bank may, for example, decide to further target the benefits associated with its subscription credit card by focusing on the streaming entertainment and gaming industries in order to provide an opportunity for consumers to save money on subscription costs associated with streaming entertainment and gaming services. In turn, the Subscription Card serves to enhance customer loyalty with the bank and/or any subscription service (e.g., entertainment and gaming) providers whose subscriptions are being paid for using the Subscription Card. Additionally, it is contemplated that a bank could partner with a subscription service provider to offer a Co-Branded Subscription Card to its customers to provide benefits on its services, or any other related industries or companies goods and services.

Variations will also be described that allow for the bank to offer benefits on multiple subscription services to offer different combinations of benefits to the Subscription Card user account(s). For example, benefits may involve an individual streaming service, multiple streaming services, or a bundle of streaming services together in a discounted package, as many consumers subscribe to multiple streaming services at a time. It is contemplated that existing or current users of the Subscription Card who refer new users to set up a credit card account can trigger benefits to the referring user (referral source) and referees, such as, but not limited to, account credits for subscription services, points, monetary incentives, cash back, percentage of spend, or rebates, etc. Such benefits are determined in part by referral source and number of downstream users who are linked to or originate from the referring user (referral source), directly or indirectly. A bank or financial institution may offer benefits for paying for any streaming entertainment or gaming service without partnering with any specific streaming service, as the bank has its own internal processes for classifying and categorizing spend on its cards.

Additionally, according to the present disclosure, a peer-to-peer marketing model for a credit card is also described. Briefly, methods for marketing the streaming credit card, along with systems for storing user information, tracking referrals, calculating, and awarding benefits to user accounts will be described. Various models of determining and issuing benefits to existing users and future users based on making referrals to prospective users will be presented, along with variations and alternatives. These models each provide incentives for users to market the subscription credit card, or any credit card that may or may not target specific industries, businesses, or categories, to peers, injecting much-needed enthusiasm into both the streaming market and credit card market.

### BRIEF DESCRIPTION OF THE DRAWINGS

FIG. 1 is a system for determining tiered credit card benefits for user credit accounts.

FIG. 2 is a flowchart illustrating an example method for determining benefits for user credit accounts.

FIG. 3 is a system for determining tiered credit card benefits for user credit accounts.

FIG. 4 is a flowchart illustrating an example method for determining benefits for user credit accounts.

FIG. 5 is a schematic drawing of a rewards model using subscriber networks.

FIG. 6 is a schematic drawing of a rewards model using tiered benefits.

FIG. 7 is a schematic drawing of a rewards model using sign-on periods.

FIG. 8 is a system for determining tiered credit card benefits for user credit accounts.

FIG. 9 is a flowchart illustrating an example method for determining benefits for user credit accounts.

FIG. 10 illustrates an example benefits model.

### DETAILED DESCRIPTIONS OF THE DRAWINGS

The following figures will describe embodiments of a system having various components for performing the computing functions of a credit card or financial communications network. These can be understood to be processors, computer-readable memory, virtual storage and the like, cooperative user-interface devices, and other known computing components. These ultimately cooperate to be used with a payment card including a physical, digital, or virtual Subscription Card, or credit card, at a point of sale, or post sale.

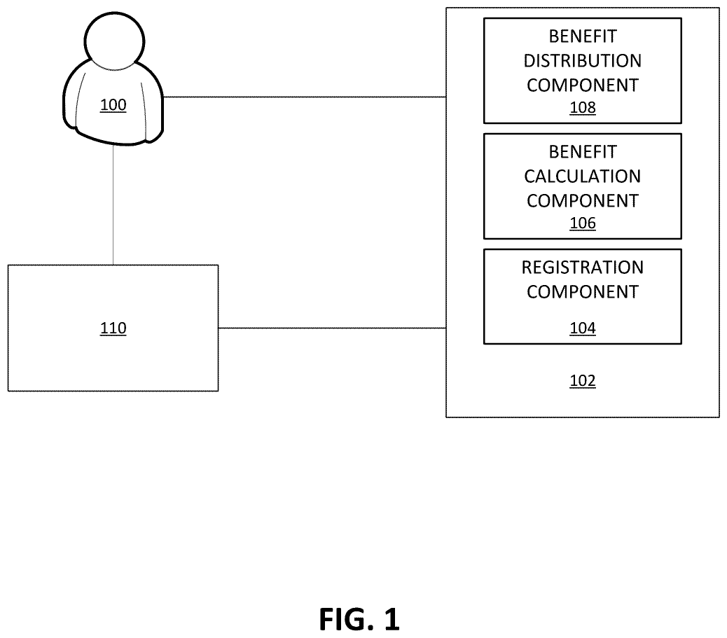

Turning now to the figures, FIG. 1 illustrates an example system for determining tiered and non-tiered credit card benefits and distributing benefits to a user. Shown is a user 100 which is connected with a Subscription Card system 102 and a bank or financial services provider 110. A user 100 can be understood as being associated with a user account created and/or stored in a registration component 104 of the Subscription Card system 102. The user account first includes login credentials which allow the user 100 to access, via a user interface, the Subscription Card system 102. The user interface that facilitates interaction with the Subscription Card system 102 can be, for example, a website, mobile app, or the like hosted on a server and made available on a web browser. The user account further includes registration data pertaining to the user 100. The registration data for user 100 includes data that may be necessary for registering for and obtaining a Subscription Card, such as personal identifying and contact information, along with payment information, such as bank accounts used for payment. The user's registration data can further include a list of services the user 100 is registered for or receives bills and charges for, or the amount the user 100 has spent on subscription service charges, or the number and type of other users or user accounts that they have referred, directly or indirectly, to get the Subscription Card, as well as the user's spending on their Subscription Cards. Such additional information is pertinent to determining benefits the user 100 receives in certain embodiments.

The Subscription Card system 102 can be understood as a network of processors, servers and virtual interfaces which function together as a system. The described components of the Subscription Card system need not be multiple physical components, so long as the Subscription Card system 102 can collectively perform the operations described herein. Included in the Subscription Card system 102 are a registration component 104, a benefit calculation component 106 and a benefit distribution component 108. The registration component 104, as previously noted, includes a database which stores records of user accounts such as that of user 100, and contains information indicating the issuance of a Subscription Card to user 100. Thus, the registration component includes a payment card status which indicates whether the user 100 has a Subscription Card. Said database can be hosted on a server, for example, or on any other suitable memory devices known in the art. The registration component 104 additionally includes a portal which prompts the user 100 to supply, directly or indirectly, the user account information to the database. Said portal can be, for example, a web page accessible by the user 100 via a user interface. The benefit calculation component 106 tracks whether or not the user has or has had a Subscription Card, as well as purchases made by the user. That is, transaction data associated with each purchase made by the user 100 using the Subscription Card is stored on a database. The benefit calculation component 106 further includes a processor which can determine, or be inputted, benefits to be credited to the user 100 based on the transaction data stored on the database. Finally, the Subscription Card system 102 can include a benefit distribution component which issues benefits to the user 100 such as a credit on the user's account, a cash reward, a gift, etc. Alternatively, the benefit distribution component 108, as well as the entire Subscription Card system 102, could instead be hosted on a proprietary system of the bank 110.

Hereinafter, a benefit can be understood to refer to a variety of rewards, such as cash-back, credits toward an account balance, points that can be redeemed for discounts, cash, gifts, a percentage of the amount spent on the card, in total or by category, and the like. In a credit card where an annual fee is required, the benefit may alternatively be credited toward the annual fee. In cases where there is a partner subscription service with the Subscription Card, benefits may further be tailored to the partner subscription service, such as a discounted membership, a free period of membership, or physical hardware able to be used together with a streaming service such as a digital media player. The calculated benefit is accordingly applied to the user account via a benefit distribution component 108 and stored in the benefit calculation component 106. While methods of assigning benefit amounts will be described as associated with the number of referrals a user makes, in some examples, it is understood that in some cases, a baseline benefit, particularly on streaming services subscriptions, can be available initially to a user who signs up for the credit card without making any referrals.

The Subscription Card may be financed by a bank 110. The bank 110 can be any financial institution that lends credit to a user 100. The function of the bank in the example system shown in FIG. 1 is to provide finances to pay for purchases made by the user 100. The bank 110 then may collect repayment plus interest from the user 100, as well as distribute benefits to the user 100. The bank 110 may also be the issuer, manager or owner of the Subscription Card system 102 in alternative examples.

Additionally, the Subscription Card system 102 may be in communication with the bank 110 such that user information and transaction information can be shared with the bank 110. The bank 110 can then determine, for example, how much is owed as a credit balance by the user 100. This may account for benefits the user 100 has accrued from subscriptions made using the Subscription Card and referrals, as will be described in further detail below.

Turning to the subscription benefits that are available to the user 100, in one example, the bank 110 may issue benefits based on charges from subscription services made on the Subscription Card. These charges may include registration data or recurring monthly subscription charges, for example. Alternatively, the systems, processes and techniques described can be applied holistically to identify and distribute benefits to a credit card in total and not be limited to a certain or specific type of industry charge, merchant category or type of charge (e.g., a subscription charge, etc.,).

One example of a subscription service is a streaming content service provider. Streaming content providers typically charge recurring fees to maintain the subscription. It is an aspect of the Subscription Card that charges from subscription services, in particular, may earn the user benefits at different rates than other charges. Thus, identifying charges that specifically come from subscription services is a capability of the registration component 104. There are other examples of subscription services aside from content streaming and gaming. For example, meal delivery kits, home security, clothing boxes, education, mobile phone and computer apps, mobile phone purchases, toys, transportation, etc. Memberships can also be understood to be subscription services. One aspect of subscription services is that an amount of money is paid regularly to receive a product or service. These payments allow the user 100 to continue a service for a limited time until another payment is made, or that recurring payments provide the user with recurring benefits. Based on the identification of the merchant as a subscription service, a user may be then entitled to greater benefits.

The bank 110 can offer rewards for any subscription service paid for using the Subscription Card, or can, for example, limit or target those benefits to streaming, gaming and entertainment subscription services, or may choose to not limit the rewards to any certain category, business, or type of spend, but rather a holistic usage of the credit card. This communication may include registration for the service, as mentioned above, or it can include charges made from the subscription service to the user's credit account using the Subscription Card. In the example shown in FIG. 1, the subscription service provider need not be in communication with the components of the system shown. That is, the registration component 104 may, through its own systems and network of partner and third-party systems, identify, or be informed by a bank's or financial institution's existing systems and network of systems, of charges made from subscription services to the user's Subscription Card account. For example, the registration component 104 may receive data pertaining to the merchant (e.g., the subscription service) making the charge, and data pertaining to the transaction. This may include the merchant's name, a classification of the merchant, the charge amount, the charge date, and other data useful for the credit card provider or bank. Based on this information, the registration component 104 may recognize that the transaction is a payment for a subscription service and the benefit calculation component may credit the user 100 accordingly with a benefit.

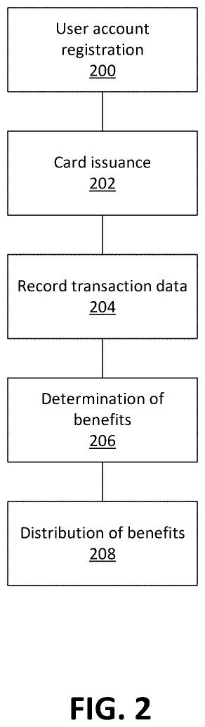

FIG. 2 illustrates an example method of benefit distribution according to one embodiment of the disclosure. In step 200, a user account is created. A user of the Subscription Card either can be assigned to or may set up a user account to apply for a Subscription Card. Step 200 may include providing user data to the registration component 104 as described with relation to FIG. 1, and may include an option of registering to receive specialty benefits related to subscription services, or those specialty benefits may come predefined and predetermined as part of the Subscription Card.

The Subscription Card may be issued to the user 100 in step 202. The Subscription Card may be issued by the bank 110 or by a third-party provider and may create a financial relationship between the user 100 and the bank 110 as described in relation to FIG. 1. Step 202 may further include recording issuance of the Subscription Card and providing financial information to the bank 110 or the Subscription Card system 102.

As the user 100 uses the Subscription Card to make purchases, transaction data is created and stored in the benefit calculation component 106, as well data relating to whether a user 100 is indicated as having or having had a subscription card (step 204). The transaction data may include, for example, the date, amount charged and the identification of the merchant and merchant category making the charge. Based on an accumulation of transaction data, in step 206, the benefits to be credited to the user 100 are calculated. This may be based, wholly or partly on entries in the transaction data relating to spending using the Subscription Card. Particularly, step 206 can include identifying spending on subscription services in an example where the user 100 earns benefits for spending on select subscription services, or if user 100 has or has had the subscription card. This can be determined, for example, by using the transaction data to determine that a select charge was made toward a covered subscription service. The determination of benefits may be made, for example, continuously as new purchases are made or at the end of a billing period (e.g., monthly). Alternatively, in one embodiment the user 100 can earn benefits for spending on any or all streaming services, instead of requiring the identification of select subscription services.

Finally, determined benefits may be issued to the account of the user 100. This may be, for example, a credit toward an outstanding balance carried by the user 100, or any other of the example benefits listed above. The distribution may be made by the benefit distribution component 108.

While the steps in the above method have been recited in order, it should be appreciated that in practice, the steps need not necessarily be performed in order and can instead be performed out of order or iteratively.

The user may also register for the subscription service or services independently of the registration component, i.e., through the service provider's website or registration portal. The registration component may communicate to one or more subscription service provider systems, or the user can enter in their subscription information manually.

There are a number of ways that the registration component 104 may identify, or be apprised of, a charge as coming from a subscription service and being therefore eligible for increased benefits. For example, the merchant may be categorized as being a subscription service, and all charges will earn the user benefits. Alternatively, the name of the specific merchant may be identified as a subscription service, or a specific dollar amount charged from a specific merchant may be identified as a subscription service. Other identification techniques for determining that a charge is from a subscription service are contemplated and may be alternatively used. In cases where a subscription charge is only one aspect of a larger business, i.e., a subscription service is only one component of a larger overall charge to a company that provides subscription services as one component of their business, whose charges are attributed to a larger parent company and thus, may not be recognized as a subscription charge, cooperation with the charging company may be useful to accurately determine that the charge is a subscription charge. The bank 110 can alternatively estimate or determine the component of a total charge that comprises the recurring, subscription portion of the total.

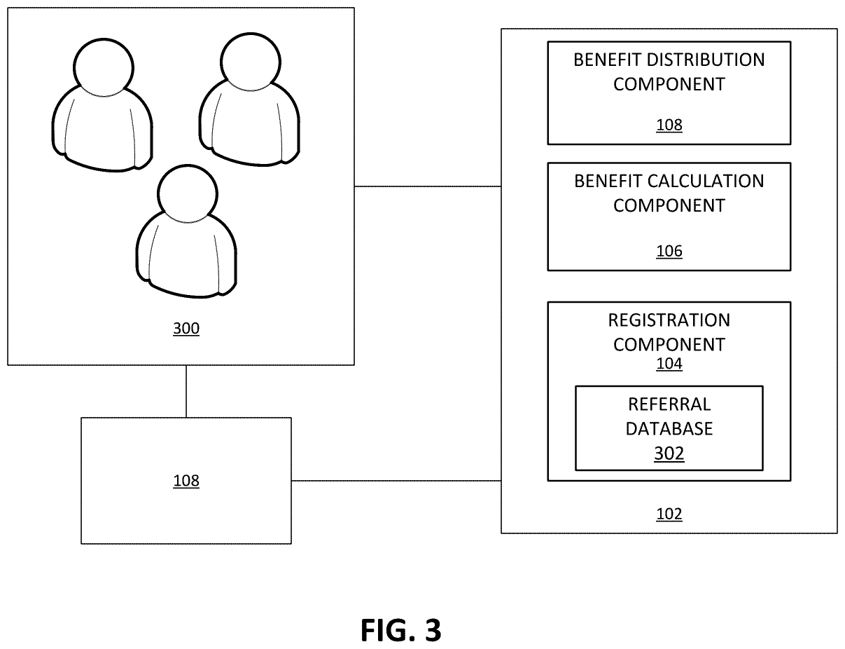

In addition to encouraging spending on subscription services with the Subscription Card, benefits can be used to incentivize users to refer the Subscription Card to other potential customers, thus, encouraging and rewarding referrals can be an important feature of the Subscription Card. FIG. 3 shows an example system of a network where a network of users 300, who either referred each other to sign up for the Subscription Card, were referred by the original user 100, and/or include the original user 100, register for credit cards and have interrelated benefit amounts. Similarly to the system shown in FIG. 1, each of the network of users 300 uses the registration component 104 of the Subscription Card system 102 to apply for a Subscription Card. In the embodiment of FIG. 3, the registration component further includes a referral database 302. Information about who the referral source of each user of the network of users 300 is (i.e., the person who referred them to sign up) is stored in the referral database 302. The data stored in the referral database 302 may also indicate whether there is a tiered chain of referrals, meaning a referral source for a user 300 was also referred to sign up by a prior user. Based on the data stored in referral database 302, benefit calculation component 106 calculates the updated benefits earned by the users 300 for making referrals, directly or indirectly, or being referred to sign up for the Subscription Card.

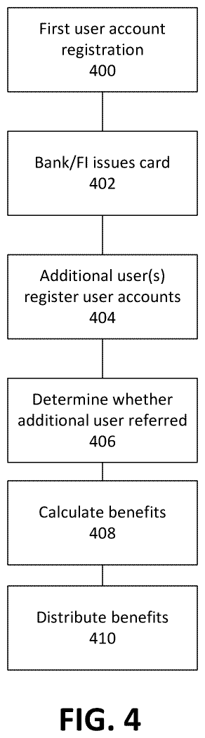

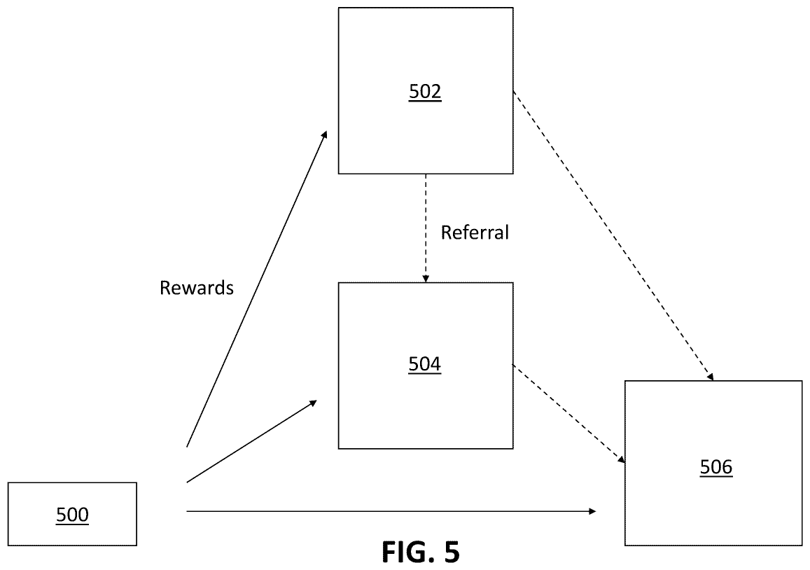

FIG. 4 illustrates an example method of benefit distribution where benefits are determined at least in part based on referrals. Similarly to the method described in FIG. 2, a user registers for the Subscription Card (step 400) and the bank 110 issues the Subscription Card to the user (step 402). In step 404 of this example, additional users register for user accounts in the same manner as the user in FIG. 2. However, the additional users indicate, or it is indicated on their behalf via an automated link, code or identification process, whether they were referred to the Subscription Card by a prior user (e.g. the first user, or any user of the Subscription Card who had previously signed up). Referrals can be made at the point where a user signs up for a Subscription Card, e.g., registration component 104. A referral may be recorded when a person registers for the Subscription Card and lists, manually or in an automated fashion facilitated by the bank or a third-party, a user as a “referrer.” This may be done via a text or numerical entry prompt when a user is signing up, or there may be a shareable link that allows a current user to share a direct link to registration to a prospective user. Other known methods of tracking referrals, directly or indirectly, and crediting the appropriate user accounts can be interchanged. Further, referrals may be made in a situation where multiple users sign up at once, as a group, or a referral can be made at some time after signing up. Referral data is thus collected and in step 406 it is determined whether the additional users were referred by prior users. The referral information determined in step 406 is used in calculating benefits in step 408. The calculation of benefits can refer to the benefits of the additional users or the prior user in this example, or both, as either the referrer or referred user can receive benefits as a result. Possible models for directly or indirectly determining referral benefits will be discussed in greater detail with regard to FIGS. 5-7. As discussed in the above, the calculated benefits can be distributed periodically according to step 410.

The number of referrals a user has made, directly or indirectly, can determine the benefit that the referring user receives, as well as the benefits that subsequent referred users receive. The number of referrals can be directly or indirectly proportional the size of the benefit a user receives, the benefit can be determined according to gradually diminishing returns, the benefit size can be based on a model of increasing returns as more users are referred, or there can be a set maximum on the size of the benefit a user can receive, or the benefit may be flat and not vary by the number of subsequent users, or any combination of the above. In addition, a referral may similarly impact the benefit the referred user receives, where a referred user receives a larger benefit if they were referred to the Subscription Card from an existing user than they would have otherwise received by signing up on their own initiative. Examples of specific models for determining a benefit will be described in FIGS. 5-7. The “size” of a benefit can be understood to mean a relative percentage cash back, dollar amount of a cash back distribution, refund of purchase or partial purchase price, or number of redeemable points, which can be smaller or larger depending on the user's position within a referral network, as will be shown in FIGS. 5-7. Additionally, a benefit can be a flat cash payment, or a percentage of money spent on the card, either in total or for a specific category, such as subscription services, based on, or based in-part on, the number of subsequent Subscription Cards that have been issued to consumers referred to the Subscription Card from a referral source.

Once a benefit is calculated, e.g. by the benefit calculation component 106, which may be a processor that assigns the benefit to the appropriate user account, and the benefit is, for example, credited or distributed toward the user or the user's account or card balance via the benefit component 106 and is communicated to the benefit distribution component 108. It is possible that any number of the participants, partners or combination thereof in this system could be issuing the benefit, a part of the benefit or any combination thereof. In one embodiment, a partnering bank can issue a cash refund towards the user account. In another embodiment, a streaming service provider could issue a credit towards their respective subscription service.

Beginning with FIG. 5, various models for determining benefits based on referrals will be described. A network of referrals may begin with an initial user who signs up for the Subscription Card and refers a network of other downstream users to sign up for the Subscription Card. The network of referrals may be most beneficial for the initial user, as the initial user will have the largest network of downstream users. However, as will become clear from the following figures, downstream users may benefit as well, and in some embodiments receive benefits equal with those of initial user.

In an example, an initial user may receive a 3% cash back benefit on their own spending using the Subscription Card (i.e., if $6500 is spent using the card over the course of a year, the initial user receives a $195 cash back benefit). If the initial user were to refer 25 secondary users, for example, the initial user may receive a small cash back benefit based on the secondary users' spending. For example, this benefit may be 1% cash back, such that if the initial user refers 25 secondary users to sign up for the card, who spend an average of $6500 in a year using the card, the initial user receives $1625.

This example may also include further downstream (third) users who are referred to sign up for the Subscription Card by the secondary users. Both the initial user and the secondary users may receive benefits based on the spending of the third users who they refer. For example, the initial user may receive a 0.9% cash back benefit on the spending of the downstream third users, such that if the 25 secondary users each refer a total of 25 downstream third users to sign up for the card, and the 25 third users each spend $6500 in a year using the Subscription Card, the initial user receives a cash back benefit of $1463. The secondary users may also receive a cash back benefit based on the spending of the third users, for example 0.95%, such that a secondary user receives $1544 in cash back benefits.

In an alternative embodiment, all users may be compensated for their direct and indirect referrals in the same manner and percentage to each other, regardless of their position within a particular network. In other words, in an alternative embodiment each user can receive the same benefits (e.g., the same percentage of cash back) on their direct and indirect referrals. In a variation of this embodiment, the networks may be configured such that downstream users have less users in their network based on the time the users joined the network but are equally compensated for each direct and indirect referral they make. Applying this framework to the example illustrated in FIG. 5, when the secondary users refer the downstream third users, the secondary users receive 1% on the spend of the third downstream users, which may be the same as the initial user was compensated based on the secondary users' spending. Thus, in this example, each user in the network makes the same percentage on the spend on the cards of all of the users they have directly and indirectly referred. The user's network can be understood as including all the downstream users that have been directly or indirectly referred by the user, and in addition to users that have directly or indirectly referred the user (i.e. including upstream and downstream users). It is also noted that in addition to receiving a percentage of spend on directly or indirectly referred cards, a user may also be compensated based on just a flat fee, or a combination of a percentage of the spend on directly and indirectly referred cards, as well as a flat fee. In sum, while initial users can receive greater compensation on spending than downstream users, a model where all users in the network receive the same benefit on spending.

The bank or financial institution may limit the amount of growth in cash back by setting limits in the amount of cash back a user receives, the number of users a cardholder can have in their network, or by adopting a diminishing returns mode. As the above is merely exemplary, the amounts of cash back, network model structure, number of users in a network, etc. may change between different embodiments.

FIG. 5 shows a network of users connected by referrals. In this embodiment, the benefit type and/or sizes are shared between referrers and referees, so that as more users are added to the network, each respective user's benefits increase. The shown embodiment of the benefit system that implements a benefit-sharing model which can be rewarding for customers who refer other customers and can provide incentives encouraging prospective customers to open a credit card. In other words, this embodiment is appealing to both entrepreneurial customers, and those who simply are attracted to the available benefits. Thus, the benefit applied to all users in a network may be equal to each other and potentially increase as more users join the network via referrals.

For example, as shown in FIG. 5, an issuer 500 issues benefits to users 502, 504 and 506, who collectively form a network via referrals. The issuer 500 can be a financial institution such as the bank 110, or alternatively can be a proprietor of the Subscription Card system 102 or a participating third party such as a subscription service. In the shown example, referrer 502 refers first referee 504 to sign up for the Subscription Card. Subsequently, second referee 506 is referred to sign up by either referrer 502 or first referee 504. These referrals have the effect of increasing the total number of users in the network to three members. In this example, all three users 502, 504 and 506 receive an equal benefit based on the network having three members. However, in alternative embodiments, benefit amounts do not necessarily have to be equal. Instead, the benefit amounts may be influenced by other factors, such as receiving increased benefits by referring more users to sign up for the card. The benefit amount may increase if more users are added to the network via subsequent referrals. The increasing benefit may be directly or indirectly proportional to the number of users in the network, i.e., each referral adds an equal-sized benefit to each user of the network. For example, a network with a size of two users can have double the benefit of a network having a single user with no referrals, and so on. Alternatively, a diminishing-returns model can be implemented where the benefit increase is smaller with each successive referral, or the benefit can continue increasing and can be potentially capped when a maximum benefit is reached.

As an example of the above, tailored to streaming services, a user who signs up for the Subscription Card may receive, for example, 20% cash back on subscription services. When the user refers a second user to the network, the shared network has a size of two members and the cash back on subscription services for both users is increased to 30%. If either of the users subsequently refer a third user to sign up for the Subscription Card and join the shared network, each user's cash back on streaming services increases to 40%, and if a fourth user is referred to the shared network, the cash back on streaming services increases to 50%. It should be understood that this model can be applied to different types of benefits and involve different incremental amounts of benefit increases. Further, there is not necessarily a limit on the number of users for which benefits may calculated and applied.

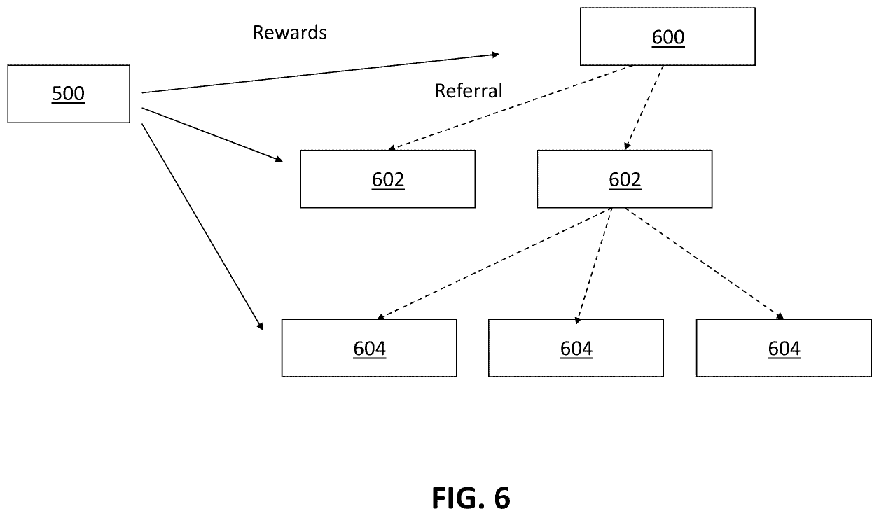

Turning now to FIG. 6, the benefit calculation component 106 of the system 102 can utilize another model to determine benefits by way of a tiered structure of referrals as shown. In the example, the issuer 500 issues benefits to first-tier users 600, second-tier users 602 and third-tier users 604. The exemplary tiering of users here is indicative of where the users are situated in relation to the other users, based on which users are referrers and which users are referees. The first-tier user 600 in FIG. 6 is the earliest user to sign up for the Subscription Card. The first-tier user 600 then directly refers second-tier users 602 to sign up for the Subscription Card and as a result, the first-tier user 600 receives an increased benefit based on the number of users the first-tier user 600 refers. In addition, the second-tier users 602 become members of the “network” of the first-tier user 600. Thus, referrals made to third-tier users 604 by second-tier users 602 who have been referred to sign up for the Subscription Card by the first-tier user 600 will increase the benefit to the first-tier user 600, as well as increasing the benefits of second-tier users 602. In other words, a user who refers the credit card to other users receives benefits from their referrals and all referrals that stem therefrom. As shown, a second-tier user 602 refers three third-tier users 604 to sign up for the Subscription Card. Both the first-tier user 600 and the second-tier user 602 receive benefits for the referrals of the third-tier users 604, and so on.

Additionally or alternatively, the benefit a referring or referred user receives may be points, cash back, a cash reward, or a percentage of the spend based on the usage and spending of a downstream referee. In other words, a user may receive a benefit when someone the user referred, directly or indirectly via their stream of referred referrals to the Subscription Card, or any credit card, spends money using the card, or possesses the card regardless of how much is spent on it. In some embodiments, these benefits may be applied to subscription service payments, and in other embodiments may be applied holistically to just the issuance of the card or the spend, in part or in total, on a credit card. By way of example, with regard to FIG. 6, if first-tier user 600 refers second-tier users 602 to sign up for the Subscription Card, the first-tier user 600 can receive benefits based on the spending of second-tier users 602 using the card on subscription payments, as well as any subsequent referred users as well that ultimately stem from second-tier users 602, such as third-tier users 604. This model can be beneficial for maximizing spending with the Subscription Card, as it encourages users to not only sign up for the card but to actively use the card, as many benefits-offering credit cards go unused after an initial promotional benefit is used up.

As an additional caveat to the model in FIG. 6, the rate at which benefits are earned may or may not be equal. The first-tier users 600 who are the earliest referrers of the Subscription Card could receive the greatest benefit from downstream spending of referred users, but again, the downstream benefits could be equal (e.g. as a percentage of spending) between an earlier referrer and downstream referee(s), or a combination of the above.

Alternatively, a variation from the model shown in FIG. 6 could determine benefits based only on direct referrals rather than factoring all subsequent referrals that flow from the direct referrals. For example, first-tier user 600 would receive benefits based on the second-tier users 602 that first-tier user 600 refers, but not receive benefits based on the third-tier users 604 that are subsequently referred. This alternative model could have the effect of simplifying the model and allowing for more control to the referring users over their networks of referrals.

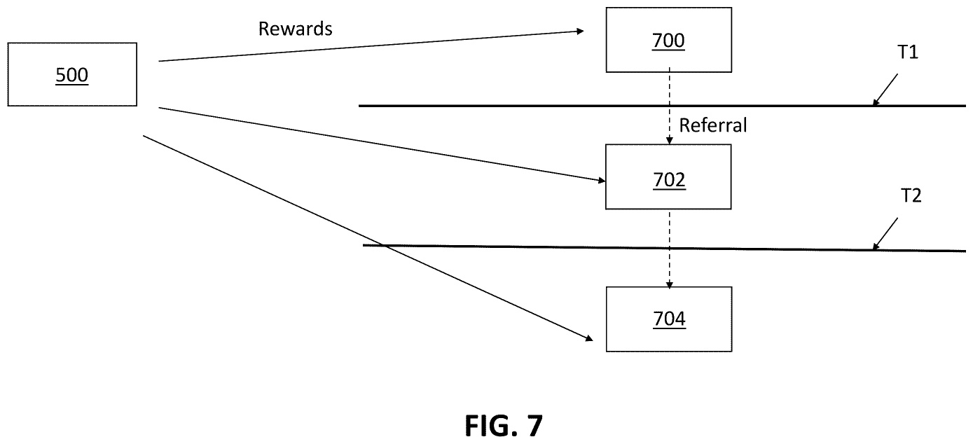

FIG. 7 shows another model where the issuer 500 issues benefits based on when a referring user and users they refer sign up for the Subscription Card. In this model, users who sign up for the Subscription Card during earlier periods may receive higher benefits, encouraging customers to sign up earlier. These periods may be determined by cut-off dates, as for example dates T1 and T2 as shown in FIG. 7. In the example shown in FIG. 7, a first user 700, a second user 702 and a third user 704 each sign up for the Subscription Card at different points in time. First user 700 signs up first, at a time before first cut-off date T1 and receives the highest benefit of the three users. Second user 702, who may or may not have been referred by first user 700, signs up for the Subscription Card at a time between first cut-off date T1 and second cut-off date T2. Second user 702 receives a lower benefit than first user 700 based on their respective dates of signing up for the Subscription Card. Third user 704 signs up for the Subscription Card after the second cut-off date T2 and receives a lower benefit than users 700 and 702. As shown, users 702 and 704 can be successively referred to sign up for the Subscription Card and thus, this model based on cut-off dates may be combined in a model based on referral-based benefits.

In addition, it is contemplated that the earliest cut-off periods do not necessarily offer the highest benefit amounts. In variations of this embodiment, the Subscription Card could offer select promotional periods where the benefit offered is increased for a limited time. Thus, users are especially incentivized to market the card to their peers during the promotional period and consequently, customers are encouraged to register during the promotional time period to take advantage of the increased benefit.

It is also contemplated that a user's subscription service accounts can be linked to their user account for the Subscription Card, as it could be beneficial to streamline subscription information for rewards, sign-in and other eases of use. The database of the registration component can securely store multiple user accounts or n number of user accounts.

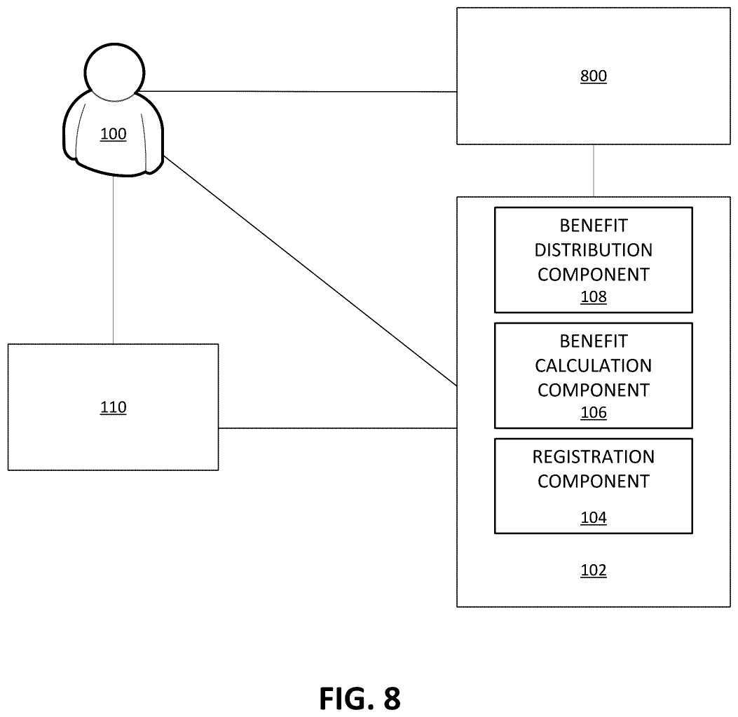

In an embodiment shown in FIG. 8, the user may purchase, renew or update a streaming account with a subscription provider system 800 through the Subscription Card system 102. Additionally, there may be multiple subscription provider systems such that the subscription provider system 800 represents a plurality of subscription provider systems including a second subscription provider system, etc. The subscription provider system 800 may be the proprietary system of a subscription service provider. The subscription service provider may be a streaming service, but it is also contemplated that this could instead be a provider of other services, subscriptions, or the like, or a bank 110.

The Subscription Card system 102, more specifically the registration component 104, may direct a user to the subscription provider system 800 via an online portal. This portal can include either a path to directly sign up for streaming services in the online portal or it may include links to leave the online portal and take the user to the streaming service's website where a user can then subscribe to the service. Alternatively, the user 100 can access the subscription provider system 800 on their own. In the case where a user is directed to leave the online portal, a user may be prompted to sign into their respective streaming account via their login information for the Subscription Card, or to enter their Subscription Card information upon signing up. In any alternative, data of the user 100 relating to the purchase of or spend toward a subscription service is shared between the subscription provider system 800 and the Subscription Card system 102.

It is also contemplated that a user 100 can register for multiple different subscription services through the registration component 104 or independently through the subscription provider system 800. As noted above, a user 100 may register for the respective subscription services through an online user portal of the registration component or user account, which could further streamline the process of registering for multiple subscription services and compiling user information. These registrations may be made individually through the subscription provider system 800 or via a bundle wherein the user may simultaneously register for multiple subscription services at a potentially discounted rate. It is contemplated that for streaming services, a bundled streaming package may be consolidated through an additional third-party provider, or through the bank 110 issuing the subscription card, that organizes agreements between multiple streaming services, and that the registration component or user account can likewise offer a bundled streaming package that organizes agreements between multiple streaming services, as well as pricing for the bundle, which may offer various promotions, or be discounted or incentivized.

When a user 100 registers at one of these subscription service providers, information related to the user's subscription, e.g. how much is spent by the user on subscriptions, what services the user is registered for, whether the user has family or individual subscriptions, etc., may be stored in the registration component 104, where information related to the user's subscriptions may be obtained directly by the registration component 104, or communicated to it, directly or indirectly, to or from the bank 110 issuing the subscription card, or by the subscription provider systems 800. This information is supplied to a benefit calculation component 106, where a benefit is calculated based on the user's subscriptions and the subscriptions identified as belonging to or being linked to the user account. The benefit distribution 108 accordingly issues the benefit to the user 100 by way of, for example, crediting their user account.

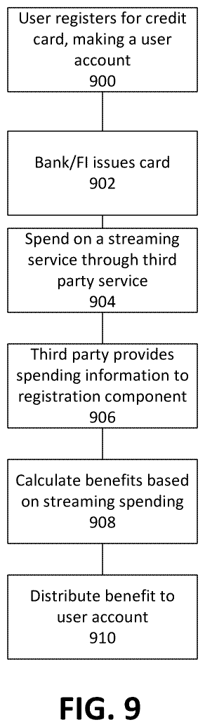

A brief exemplary method of implementing a system similar to that of FIG. 8 which involves a third-party partnering subscription service provider is shown in FIG. 9. Similarly to the method described in FIG. 2, a user registers for the Subscription Card (step 900) and the bank 110 issues the Subscription Card to the user 100 (step 902). When the user 100 has an active Subscription Card, the user 100 then is free to spend on and may even be encouraged to use the Subscription Card to spend on partnering subscription services through the proprietary system of the subscription service (step 904). Once the user 100 has completed a purchase or spend through the subscription service's system 800, the subscription service provides spending data to the subscription card system 102, specifically the registration component 104 that tracks user information, such that the user 100 may be rewarded for their spending (step 906). Alternatively, the Bank 110 may identify the subscription charges from its own proprietary systems, networks and data. The benefit calculation component 106 of the subscription card system calculates the benefits to the user 100 (step 908). As discussed in the above, the calculated benefits can be distributed periodically according to step 910.

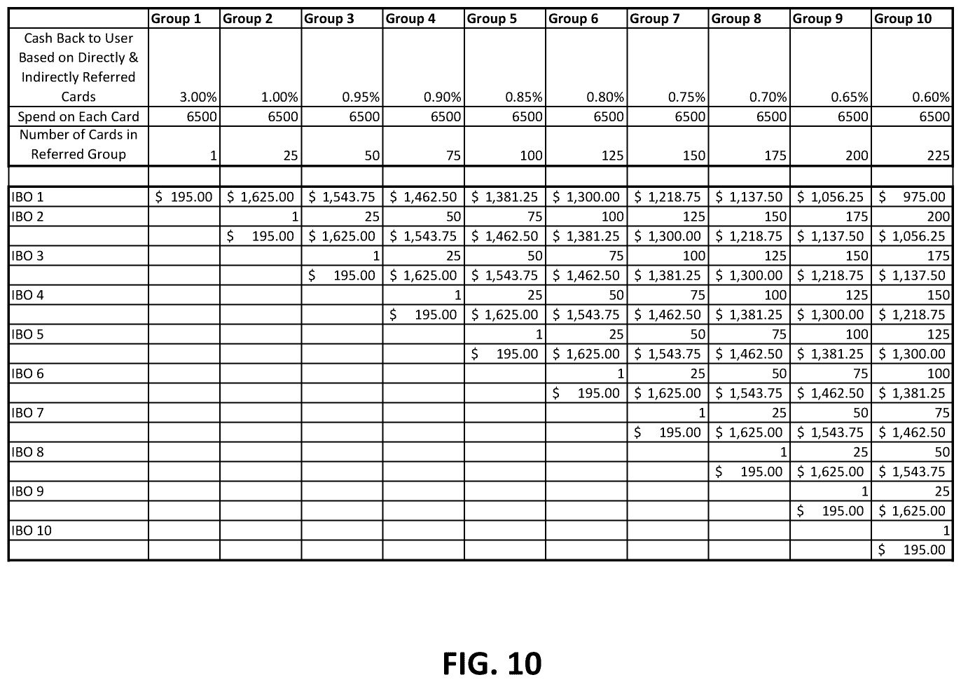

FIG. 10 shows an exemplary embodiment of a benefits model where independent business owners (IBOs) are able to market the Subscription Card to consumers, as well as to other IBOs, and receive benefits based on the referred consumers and other IBOs. In reference to FIG. 1, the benefit calculation component 106 can make use of the benefits model as discussed in FIG. 10 to determine the benefits due to user accounts and then the benefit distribution component 108 can distribute those benefits (e.g., funds) to the indicated accounts. It should be understood that an IBO is a type of user 100 having a user account as discussed in the preceding figures.

In FIG. 10, the benefits to IBOs who market the Subscription Card are shown. Each IBO may receive a predetermined benefit amount (i.e. a percentage of cash back) based on the spending on the Subscription Cards that they market. For example, IBO 1 receives 3% cash back on their own spending and 1% on the spending of their direct referrals. These direct referrals are shown as consumers of Group 2. In addition, IBOs such as IBO 1 can recruit others to become IBOs and receive benefits based on the spending of the downstream consumers (indirect referrals) referred by the subsequent IBOs. For example, FIG. 10 shows a chain of IBOs, beginning with IBO 1 who refers IBO 2, who in turn refers IBO 3, etc. The descending percentage benefits to IBO 1 are shown near the top of FIG. 10. For example, IBO 1 receives 0.95% cash back on the spending of the consumers in Group 3 (the referred consumers of IBO 2), 0.9% cash back on the spending of the consumers in Group 4, and so on. FIG. 10 specifically shows a scenario where each consumer spends $6500 annually using the Subscription Card, and each Group is a group of 25 consumers that are referred to sign up for the Subscription Card by one of the IBOs. In addition to the benefits of IBO 1, the lower section shows how much each IBO receives in cash back from each group.

As shown in FIG. 10, the IBO 1 receives a 3% cash back benefit on their own spending using the Subscription Card (i.e., if $6500 is spent using the card over the course of a year, IBO 1 receives a $195 cash back benefit). When IBO 1 refers 25 consumers which form Group 2, the IBO 1 additionally receives a cash back benefit based on the consumers in Group 2's spending. When IBO 1 refers 25 consumers in Group 2 to sign up for the card, who spend an average of $6500 in a year using the card, the User 1 receives $1625. When IBO 2 refers 25 consumers (Group 3) to sign up for the Subscription Card, IBO 1 receives $1543 based on 0.95% cash back and IBO 2 receives $1625 based on 1% cash back.

In view of this example, it is clear how a user's cash back benefits and rewards can grow exponentially. As shown, the model can be extended to an N number of downstream users and customers. Thus, an environment is created where it is desirable business opportunity for cardholders to market the Subscription Card on their own. Of course, the relative cash back percentages and other components of the model may be adjusted as the model shown in FIG. 10 is not meant to be limiting.

Throughout the disclosure, an example of a subscription service has been a streaming content and entertainment service provider. Considering the above, the streaming industry is in desperate need of a solution that promotes enthusiasm among its user base and alleviates the high subscription costs that discourage customers from maintaining their subscriptions. At the same time, credit card companies are in need of a product that provides a unique advantage over competitor credit cards. Thus, a Subscription Card according to the present disclosure where the subscription service benefits are in relation to a content streaming service addresses both of these problems and offers various systems and models implementing such a credit card.

A bank or financial institution can create, build and manage this entire peer-to-peer credit card marketing process, focusing on the subscription economy as a whole, or certain segments of it or not focus on any certain industries or segments of the economy, with or without any other partners or third-parties, by setting up and establishing its own user account input and user identification process, registration component, user network tracking component, benefit tracking and calculating component and benefit distribution component. The bank or financial institution further can identify any and all related and applicable subscription services and subscription payments or charges from its own analysis of data usage, spend, subscription charge, and payments obtained from its own data and network or systems. Additionally, it may also leverage systems, data, and networks from credit card associations, such as Visa, Mastercard, Discover and American Express, or other payment processors and service providers, and the like. Finally, the identification and tracking of a payment for a subscription service, as previously described, can be used to determine if a user has subscribed to a subscription service or is a member of a subscription-related service.

While several alternatives of benefit models have been described throughout the figures and accompanying descriptions, it is readily imagined how the concepts of each model can be combined, or alternatively applied holistically to the issuance and possession of a credit card, or the spend on that card. Thus, the benefit a user receives may be holistically determined based on a combination of factors that have been described throughout. Further, it should be understood that variations and modifications may occur to those skilled in the art to which the claimed examples pertain.

1. A system for determining tiered and non-tiered benefits comprising:
a registration component configured to store user-identifying information of a user account,
a benefit calculation component having a referral database, the referral database storing referral records indicating a number of referrals made by an account holder of the user account, the benefit calculation component configured to determine a benefit based on the number of referrals made by the account holder; and
a benefit distribution component configured to distribute or credit the benefit to the user account based on the number of referrals made by the account holder.

2. The system of claim 1, wherein the account holder makes a referral to a second account holder of a second user account.

3. The system of claim 2, wherein the referral is determined in the benefit calculation component when the second user account is created.

4. The system of claim 3, wherein the second account holder makes a second referral to a third account holder of a third user account, and
wherein the first user account receives a first benefit as a result of the second referral and the second user account receives a second benefit as a result of the second referral.

5. The system of claim 1, wherein the first benefit and the second benefit are equal amounts or equal percentages of spend.

6. The system of claim 4, wherein the first benefit and the second benefit are determined according to a tiered benefit structure that assigns different amounts to the first and second benefits.

7. The system of claim 1, wherein the registration component is configured to identify subscription information based on credit card transaction data.

8. The system of claim 1, further comprising a network of user accounts including the at least one user account wherein benefits to all of the user accounts are determined based on the number of user accounts in the network.

9. The system of claim 1, wherein the benefits are additionally determined by a number of subsequent referrals made by an additional account holder referred by the account holder.

10. The system of claim 3, wherein the benefits are additionally determined based on a period of time in which the referrals are made.

11. A method for determining tiered and non-tiered benefits, the method comprising:
registering a user account;
issuing a payment card
recording issuance of the payment card;
recording transaction data of spending using the payment card;
registering subsequent user accounts;
determining whether the subsequent user accounts were referred by an account holder of the user account;
determining benefits earned by the user account based on the issuance of payment cards to the subsequent user accounts or the transaction data of spending using the payment card by the user account and subsequent accounts referred; and
distributing the benefits to a user account.

12. The method of claim 11, the method further comprising:
determining whether the transaction data includes charges made toward subscription services; and
determining the benefits earned by the user account based on the charges made toward the subscription services.

13. The system of claim 1, wherein the benefit is a discount of the subscription service, cash back, cash payments, points, a credit, or a percentage of spend.

14. The system of claim 1, wherein the registration component is configured to store payment card status and spend information related to a payment card of the first user account and of the referred user accounts, the payment card status and spend information indicating whether the first user account and the referred user accounts are in possession of the payment card, payment categories, and an amount of spend on the payment card, and
wherein the benefit calculation component is configured to determine the benefit based on the payment card status of the user account and the referred user accounts or spend information of the user account on the payment card and the spend information of the referred user accounts on the payment card.

15. The system of claim 14, wherein the benefit is a discount of a certain category or type of spend, cash back, cash payments, points, credits or a percentage of the spend for the first user account or the subsequent user accounts.

16. A system for determining tiered and non-tiered benefits comprising:
a registration component configured to store user-identifying information of a user account;
a benefit calculation component having a referral database, the referral database identifying at least one account referred by the account holder of the user account, the at least one account referred by the account holder being identified as in a shared network with the user account and each of the other ones of the at least one account referred by the account holder,
wherein the benefit calculation is configured to determine a benefit for the user account and each of the at least one account referred by the account holder based on a number of user accounts in the shared network; and
a benefit distribution component configured to distribute or credit the benefit to the user account.

17. The system of claim 16, wherein the benefits of all members of the shared network are equal.

18. The system of claim 16, wherein the benefit is a percentage of cash back spent on a subscription service.

19. The system of claim 16, wherein the number of members of the shared network is capped at a predetermined maximum.
